(19) United States
(12) Patent Application Publication
(10) Pub. No.: US 2003/0018584 A1
(43) Pub. Date: Jan. 23, 2003

(54) System and method for analyzing transaction data

(76) Inventors: Jeremy Stein Cohen, Sunnyvale, CA (US); Ashok Narain Srivastava, Mountain View, CA (US)

Correspondence Address: HOWREY SIMON ARNOLD & WHITE, LLP, BOX 34, 301 RAVENSWOOD AVE., MENLO PARK, CA, 94025, US

(21) Appl. No.: 09/912,280

(22) Filed: Jul. 23, 2001

(51) Int. Cl. G09G 5/00

(52) U.S. Cl. 705/52

(57) ABSTRACT

The present invention provides management of transaction data effectively to process, store, analyze, review, and visualize transaction data. The present invention is compatible with transaction data from internet accesses to Web-sites. The present invention provides a unified data collection and processing scheme with an interactive visualization tool for the processed data. The present invention receives transaction data and then processes this transaction data to create an efficient data structure representing the data. As a result, the present invention also provides an interactive visualization tool for the strategists, transaction data maintenance personnel, and Web-site maintenance personnel to effectively and efficiently review transaction data to provide a convenient tool for managing transaction data or a Web-site and visualizing its effectiveness. Furthermore, the present invention also provides for the aggregation of such transaction data.

### FIELD OF THE INVENTION

Transaction data is data that represents the specific elements of transactions. The present invention relates to the field of transaction data and Web-site management, visualization, and information processing. Specifically, the present invention involves software programs, visualization tools, and data structures for storing, processing, analyzing, and visualizing transaction data and Web-site usage data on a computer and other processing devices in a variety of formats. The present invention also provides for the aggregation of transaction data. The invention can be implemented in computer hardware and/or computer software executed by computers well known to those of ordinary skill in the art.

### BACKGROUND OF THE INVENTION

I. The Web

The Internet is a global network of computers and computer networks (“the Net”). The Internet connects computers that use a variety of different operating systems or languages, including UNIX, DOS, Windows, Macintosh, and others. With the increasing size and complexity of the Internet, tools have been developed to find information on the network, often called navigators or navigation systems. Examples of such navigation systems include Archie, Gopher, and WATS. The more recently developed World Wide Web (“WWW” or “the Web”) is one such navigation system that also serves as an information distribution and management system for the Internet.

The Web uses hypertext and hypermedia. Hypermedia is any media that allows users to transit between and within various types and sources of media. Hypertext is a subset of hypermedia and refers to a system that utilizes computer-based “pages” in which readers move within a page or from one page to another page in a non-linear manner by using hyperlinks. Hyperlinks are links embedded within a Web-page that allow Web-site visitors to navigate to other Web-pages. The Web uses a client-server architecture to implement hypertext. The computers that maintain Web information are called Web-servers. A Web-server is a software program on a Web host computer that answers requests from Web-clients, typically over the Internet. The Web-servers enable a Web-site visitor to access hypertext and hypermedia pages from Web file servers. A Web-client is a software program on a computer that requests data from Web-servers. The Web-clients enable a Web-site visitor to access the Web-server. The Web, then, can be viewed as a collection of pages (residing on Web host computers) that are interconnected by hyperlinks using networking protocols, forming a virtual “Web” that spans the Internet.

A Web page viewed by a Web-site user, or visitor, (via the Web-site visitor's computer monitor or other display device) may present simple text only or may appear as a complex document, integrating, for example, text, images, sounds, and/or animation. Each such page may also contain hyperlinks to other Web pages, such that a Web-site visitor at the client computer using a mouse may click on an icon or other item to activate a hyperlinl to jump to a new page on the same or a different Web-server.

A Web-server can log activity information regarding a user's Web-client requests for information via a Web-client. For each such client request, a Web-server can record the Internet address of the client, the time of the request, the page requested, the information requested or other information. The Web-server may also record other data as the operator of the Web-server sees fit.

II. Graphs

Graphs are used to describe interactions between various elements. A graph is defined as a set of nodes and associated arcs. In a graph, an arc represents an interaction or relationship between two nodes. In a directed graph, the arcs are directional in that a directed arc traveling from a first node to a second node indicates only an effect or relationship of the first node upon the second node. In an undirected graph, undirected arcs between pairs of nodes represent an interaction or relationship between the nodes in both directions.

III. OLAP

On-Line Analytical Processing (OLAP) is a computing technique for summarizing, consolidating, viewing, applying formulae to, and synthesizing data in multiple dimensions. OLAP software enables OLAP-users, such as analysts, managers, and executives, to gain insight into performance of an enterprise through rapid access to a wide variety of data. The data is organized to reflect the multidimensional nature of the enterprise performance data. An increasingly popular data model for OLAP applications is the multidimensional database (MDDB), which is also known as the data cube.

To create an MDDB from a collection of data, a number of attributes associated with the data are selected. Some of the attributes are chosen to be metrics of interest and each metric may be referred to as a “dimension”. Dimensions usually have associated “hierarchies” that are arranged in aggregation levels, providing different levels of granularity. U.S. Pat. No. 6,078,918, which discloses additional details of OLAP enablement is hereby incorporated by reference.

Exploration of the data cube typically begins at the highest levels of the dimensional hierarchy. Each dimension is searched for relevant data. A limitation of OLAP and the MDDB structure is the inability to represent data (such as transaction or clickstream data) that does not store efficiently in the form of a hyper-cube. The present invention overcomes that and other limitations and provides an efficient way to represent, process, search, analyze, and visualize transaction or clickstream data.

IV. Transactions

Transactions are any type of actions or data that may be described using three or more fields. The three main fields are an identifier field which identifies who or what is performing the transaction, a label field which indicates the transaction the performer of the transaction undertook, and a date/time or sequence field which indicates the order in which each action was taken by the performer of the transaction. Transaction data may be unordered or ordered. When ordered, methods of ordering of transaction data may include by time of the time/date field, by alphabetical order of the identifier field, or by alphabetical ordering of the label field.

V. Clickstream Data

Clickstream data are transaction data generated by a Web-server responding to page requests. The Web-server stores the dates and times of all page requests to the Web-server. Each of these page requests is a single transaction and an individual member of the clickstream data. The Web-server may also store other various characteristics of the page requests with the aforementioned date and time for the individual member. Clickstream data is ordinarily a list of page requests with associated data stored on a storage medium. The present invention may obtain clickstream data from a storage medium in order to process and analyze the clickstream data.

VI. COLAP

Clickstream on-line analytical processing (COLAP) is a portion of the present invention. Much like OLAP, COLAP is designed to enable computing techniques for summarizing, consolidating, viewing, applying formulae to, and synthesizing stored data. However, COLAP allows these computer techniques to be extended to data that does not aggregate into the form of a MDDB. For instance, COLAP can be used to apply these computer techniques efficiently to clickstream data or any other form of data separable into discrete transactions.

VII. Visualization

Visualization tools are computer generated graphics drawn to represent data. These visualization tools are typically implemented to allow users to view large or complex data sets in a concise graphical representation. The graphical representation is meant to allow the data to be understood more easily and more quickly than merely reviewing the raw data. Visualization provides the user of the visualizer the ability to quickly read and view various data sets and other information. Typically, visualization is implemented through a graphical user interface (GUI). The GUI provides the ability to interactively select and focus in on the data that is found to be most useful. Focusing in on data allows the GUI-user to display the data he or she finds most relevant in the manner best suited for the data.

### OBJECTS AND SUMMARY OF THE PRESENT INVENTION

The present invention has several objects. It is an object of the present invention to efficiently process transaction or clickstream data describing the choices made in a set of transactions or such as those made during an End-User's visit(s) to a Web-site. It is also an object of the present invention to create an efficient data structure to represent and store transaction or clickstream data. It is a further object of the present invention to implement visualization tools to quickly interact with and search the data structure to efficiently view transaction and clickstream data.

The present invention provides a system, method, and data structure for storing and analyzing transaction data which overcomes the visualization, storage, and analysis shortcomings of the data systems, methods and data structures of the prior art.

One component of the present invention is a method of analyzing transaction data in several steps. First, a label may be selected from a group of labels in a database of transaction data. Next, based on the selected label, a group of labels is selected from the database of transactions. Then, the transaction data concerning the group of labels is presented relative to the selected label in some aspect.

Another aspect of the invention is a unique data structure. This data structure may contain two fields. First, it may contain a field representing the number of times an individual label may have occurred. Second, the data structure may contain a field containing a representation of transitions between the individual label and other or the same individual labels. The data structure may also be aggregated with other data structures to make a unique graph capable of storing transaction data.

A further aspect of the present invention is a computer-readable medium having computer-executable instructions for performing a method of analyzing transaction data. The method may first comprise selecting an individual label from a group of individual labels in a transaction database. Second, individual labels performed before and after the selected individual labels may be identified. Third, the transaction data may be presented based on the selected label.

Another aspect of the present invention is a computer system having a graphical interface, including a monitor or other display device, a selection device, and a method of providing and selecting from a menu on the display device. The method involves displaying a set of menu entries for the menu, each of the menu entries representing an action to perform with transaction data, on a display device, thereby providing a user with an opportunity to modify the parameters and to indicate a menu entry selection via the selection device. Next, a search of a database may be performed for a match of the transaction data corresponding to the parameters and received menu entry selection.

Another aspect of the invention is a set of application program interfaces, which may be embodied on a computer-readable medium, for execution on a computer in conjunction with an application program that presents transaction data of interest to a user.

A further aspect of the invention is a method of aggregating data by creating a COLAP-graph representation of the data. The aggregation may also be accomplished by creating a hybrid COLAP-graph representation of the data.

The present invention permits transaction or clickstream data to be stored effectively in a data structure. In one embodiment, the data is represented in a computer medium in a group of unique data structures. The group of data structures is characterized by a root node representing a page. There are then paths of directed arcs to other data structures representing individual labels or pages. These paths exist if and only if the transaction or clickstream data shows that there was a transaction or some other form of association between one individual label or page to the other. A directed arc between two individual page-nodes, representing two individual labels or pages, means that there is a transition or some other form of association between the two individual labels or pages in the transaction or clickstream data. After all of the individual labels' or pages' graphs are assembled, the roots of the graphs may be aggregated into an array.

The present invention permits transaction or clickstream data to be searched efficiently through the data structure of the present invention. The transaction or clickstream data for each individual label or page may be an individual data structure. Such data structures may then be searched to allow the user to efficiently access and analyze transaction or clickstream data.

The present invention permits strategists and site-maintainers to visualize and analyze transaction or clickstream data in meaningful ways, thus providing insight into how End-Users interact with the Web-site or other transaction-oriented system. The COLAP data may be visualized in a single window that may be referred to as, the “visualizer”. One benefit of the present invention may be to provide an analyst with the ability to view the likelihood that a given individual label or page is visited by a Web-site visitor a certain number of steps before or after a different specified individual label or page. The data may be brought to the visualizer through a function implemented to search the COLAP database.

### BRIEF DESCRIPTION OF THE DRAWINGS

The present invention may be better understood with reference to the detailed description in conjunction with the following figures where like numerals denote identical elements, and in which:

FIG. 1 shows an exemplary set of clickstream data for a single session.

FIG. 2 shows an exemplary display of a view of aggregated data of a data cube for an OLAP session.

FIG. 3 shows an exemplary display of a page-node data structure utilized in the present invention to represent the data of a single page.

FIG. 4 shows an exemplary display of aggregated data of a 3-dimensional array.

FIG. 5 shows an exemplary model of a graph of associated COLAP data structures representing the connectivity of one exemplary root page-node.

FIG. 6 shows an exemplary multi-dimensional array capable of storing COLAP data.

FIG. 7 shows an exemplary model of an array of COLAP-graphs. Each element of the array is a page-node information data structure and a root node for a COLAP-graph.

FIG. 8 shows an exemplary matrix data structure used to record the number of transitions to other pages at a particular page.

FIG. 9 shows the hybrid structure of an exemplary matrix and COLAP-graph used to record the number of transitions to other pages from a particular page.

FIG. 10 is an exemplary terminal matrix for a hybrid COLAP-graph.

FIG. 11 shows a flow diagram of the present invention searching and processing an array of COLAP-graphs to obtain data.

FIG. 12 shows a program storage device having a storage area for storing a machine readable program of instructions that are executable by the machine for performing the method of the present invention of visualizing transaction or clickstream data.

FIG. 13 shows an exemplary screen of the user visualization tool of the present invention.

FIG. 14 shows an exemplary screen of the user visualization tool of the present invention after a Retarget-on-Target Action is performed.

FIG. 15 shows an exemplary screen of the user visualization tool of the present invention, displaying lift calculations.

### DETAILED DESCRIPTION OF THE VARIOUS EMBODIMENTS

I. Definitions:

Adjacency: For a page-node to be adjacent to another page-node one must be able to transition between the page-nodes. For page-node A to be forward-adjacent to page-node B means that page-node B is accessible through page-node A. For page-node A to be reverse-adjacent to page-node B means that page-node A is accessible through page-node B. The same is true for pages.

Attribute Data: Data that defines the specifics of a particular transaction. Attribute Data comprises the associated transaction's Session Attribute Data. It also may contain data specific to the transaction such as the transactions time of occurrence.

Click-step: A click-step is one transition. A forward click-step would be the next click-step in a sequence from a given click-step. A reverse click-step would be the previous click-step in a sequence from a given click-step.

Clickstream: A clickstream is a set of transitions that comprises a session on a Web-site or other interactive electronic media.

Clickstream data: Information regarding a set of sessions (and their corresponding requests) made by Web-site visitors. For instance clickstream data may have two fields: session viewing the page and page viewed.

Content: The text, images, video, audio or other media displayed or made available for download on a page.

Discrete Transaction: A single, separable transaction.

End-User: An entity creating transaction data such as a Web-site visitor.

Focal-node: The page-node representing the label or page on which a User wishes to center a data search.

Page: A particular combination of content served to a Web-site visitor in response to a particular request.

Page-node: The node representing a particular page or label and some or all of its associated elements.

Request/Click/Transition: An action taken by a Web-site visitor on a page which triggers the server to serve a (potentially different) page.

Sequence: A list of pages accessed by a Web-site visitor during a session.

Session: A chronological sequence of page requests made by the same Web-site visitor during a continuous period of use of a Web-site. Each session contains transactions. The transactions within a session share the session's Session Attributes.

Session Attribute: An attribute describing a Web-site visitor's profile such as total number of requests (clicks), gender, income or geographic location, for example. More generally, a session attribute may be any piece of data that is associated with a session. The session attribute may also be data concerning the session such as the session's start time and total number of transitions.

Set of Transaction Data: All possible transactions available. All individual transactions will be members of the Set of Transaction Data.

Template: A framework for a page, specifying the types of content to be (possibly dynamically) shown on the page.

Transaction Attribute Data: Same as Attribute Data.

Transaction Data: A set of one or more individual transactions.

Transition: A transition is a Web-site visitor request to access a page that may differ from the page the Web-site visitor is currently accessing.

URL: The address of a page on the WWW. It is an acronym for uniform resource locator.

User: A person operating the present invention.

II. Description

The present invention can be embodied as a software application resident with, in, or on any of the following: a database, a Web-server, a separate programmable device that communicates with a Web-server through a communication means, a software device, a tangible computer-usable medium, or otherwise. Embodiments comprising software applications resident on a programmable device are preferred. Alternatively, the present invention can be embodied as hardware with specific circuits, although these circuits are not now preferred because of their cost, lack of flexibility, and expense of modification.

The present embodiment of the invention is directed to clickstream data. As clickstream data is merely a type of transaction data, the applicability of the present invention to other types of transaction data should be obvious to those of ordinary skill in the art.

Transaction data may come from many sources. These sources include Web-sites, grocery checkout registers, gas station receipts, and any other place where actions are performed by entities at specific times or in an order. Any set of transaction data may be modified to be clickstream data and be incorporated and viewed with the described embodiment of the invention.

One method of converting transaction data to clickstream data is to change the transaction data “identifier” field to the clickstream “session viewing the page” field. Then the transaction data field “label” may be changed to the clickstream data “page viewed” field. Last, the transaction data “date/time” field can be used to order the clickstream data. This ordering may be by time of the transaction. The ordering may also be performed to keep all “identifiers” or “session viewing the page” separated. The ordering also may be some combination of the two aforementioned orderings.

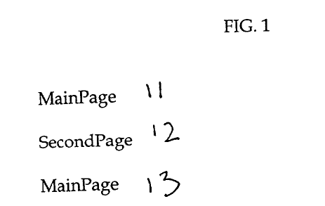

FIG. 1 shows an exemplary set of clickstream data. The clickstream session data comprises a list of pages. The list is ordered in the sequence in which the Web-site user visited the various pages on the Web-site during his or her session. In this example the Web-site visitor accessed “main page” 11 first, as it is the first member of the clickstream data list. The Web-site visitor then viewed “second page” 12 second, as it is the second member of the list. Finally, the Web-site visitor returned to “main page” 13. The clickstream data may also contain other attributes such as the time of the request or the URL of the requester.

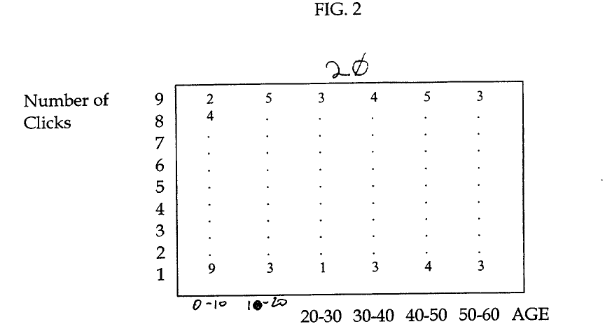

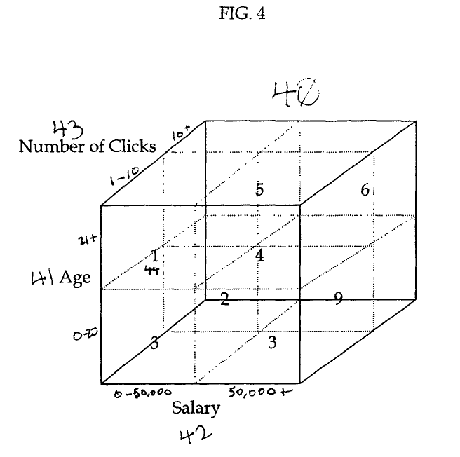

FIGS. 2-5 show data structures that may be used to represent or store clickstream data. The present invention may employ the OLAP data structure to store much of the attribute data. OLAP provides the advantage of a proven and efficient method of retrieving data. However, other means may be used to store attribute data, such as the multidimensional array of FIG. 4. Examples of possible elements of session Attribute Data could include: Last Page, Referring Page, Referring Query, Request Date, Request Time, Session Number, or Template Number. Other Attribute Data could be used in addition or in place of any or all such examples.

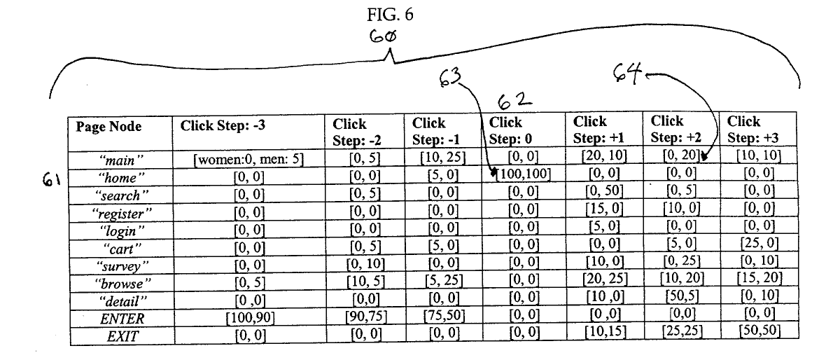

Referring to FIG. 6, one of ordinary skill in the art may see another embodiment of means to store session data for each page-node. The structure in FIG. 6 is centered around the “home” page-node 61. Thus, in the column corresponding to “Click-Step 0” 62, the only non-zero entry is the entry 63 in the row corresponding to the “home” node. The entry 63 is “[100,100]” which represents that the transitions through the “home” page-node included 100 transitions by women and 100 transitions by men. The data corresponding to the click-steps other than “Click-Step 0” represents viewing of other pages by women and men, respectively. For instance, the entry corresponding to page-node “main” and “Click-Step+2” 64, may show that zero transitions through the “main” page-node two click steps after viewing the “home” page-node were performed by women. On the other hand, entry 64 may demonstrate that twenty transitions through the “main” page-node were performed by men two click-steps after viewing the “home” page-node. Thus, each entry in the table may be a multi-dimensional array whose entries represent the number of transitions by people in each category who transitioned through (viewed) the corresponding page-node a given number of click steps before or after the focal-node. The employed data structure may contain one or more such matrix for each page-node.

FIG. 2 shows an exemplary display 20 of the view of aggregated data of a data cube for an OLAP session that may be used in the present invention. Display 20 shows a tabular display of a 2-dimensional (“2D”) hyper-cube displaying data for the number of clicks versus age. The table's values are the number of distinct clickstream sessions that match the attribute ranges.

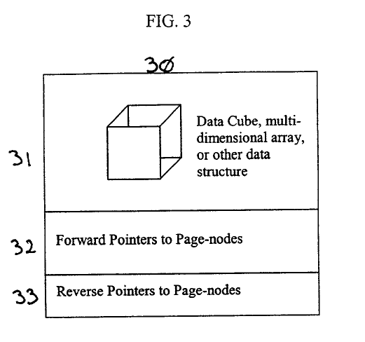

FIG. 3 shows an exemplary page-node data structure 30 that may be utilized in the present invention. The first element 31 of the data structure may be a multidimensional array containing the number of transitions through the page-node organized by Attribute Data. The axes' descriptors of the multidimensional array may correspond to the Attribute Data types. The second element 32 of the data structure may be an array of pointers signifying pages that were requested (clicked) by Web-site visitors while at the current page. These pointers may represent forward adjacencies or subsequent pages in a session. The third element 33 of the data structure may be an array of pointers signifying pages that were visited by Web-site visitors immediately prior to the current page. These pointers represent reverse adjacencies.

Every page may be represented as a node in a graph, with directed arcs emanating from the node. It will be noted by those skilled in the art that a Web-site visitor could be any person, entity, or otherwise performing a transaction. Further, those skilled in the art will note that a number of data structures may be used to store page-node data. The use of the data structure of FIG. 3 is expressly not meant to limit the scope of the invention to the exact data structure of FIG. 3.

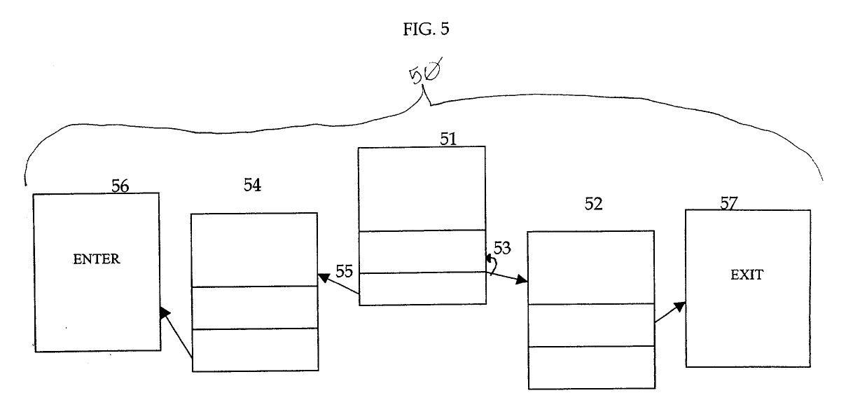

FIG. 5 shows an exemplary model 50 of a graph of associated COLAP data structures representing the connectivity of a page-node. The structure is a directed graph and referred to as a “COLAP-graph”. In this example, element 51 is the root-node (root page-node) of the graph. Page-node 52 is a dependency of page-node 51. The dependency is demonstrated by the directed arc 53 connecting page-node 51 to page-node 52. Directed arc 53 emanates from the forward pointer storage portion of data structure 51 and points to data structure 52. Therefore, page-node 52 is also a subsequent page-node to page-node 51. Page-node 51, the root node, may be accessed through page-node 54. The dependency is demonstrated by directed arc directed arc 55 emanates from the backward pointer storage portion of data structure 51 and points to data structure 54. Therefore page-node 54 is also a previous page-node to page-node 51. There are also dummy page-nodes for entrance 56 and exit 57 of the Web-site or set of transactions. These dummy nodes represent page-nodes for entering and leaving the Web-site or set of transactions, but the two nodes, “enter” and “exit”, may be virtual nodes and not necessarily actual pages. It will be noted that FIG. 5 is an example to describe the structure of a COLAP-graph, and several arcs and data structures may be missing.

FIG. 4 shows an exemplary data structure 40 of aggregated data of a 3-dimensional data array representing the transitions through a single page. It contains three attribute indices: age 41, salary 42, and number of clicks in the session 43. The values within the array indicate the number of sessions that transition through the particular page with the corresponding attributes. For instance, the array entry “1” 44 denotes that one session passed through this particular page with the attributes of the session being over 21 years of age, having a $0-$50,000 salary, and containing 1-10 transitions.

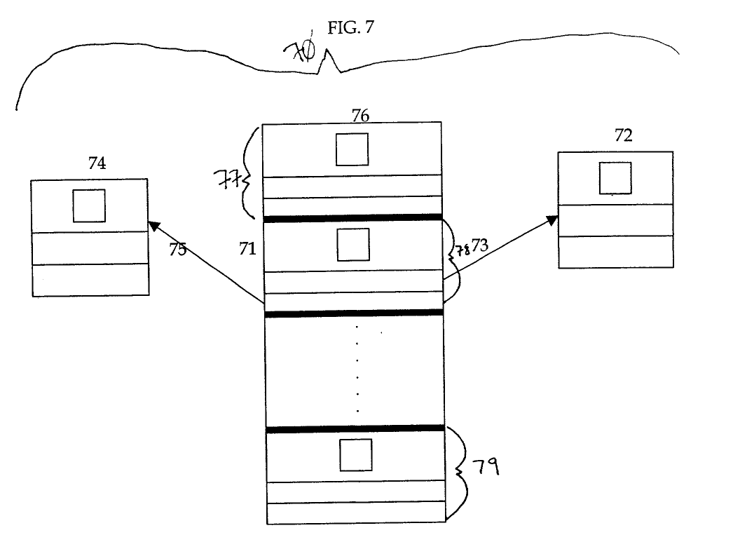

FIG. 7 shows an exemplary model 70 of an array of COLAP-graphs of COLAP data for a Web-site. The base of the data structure is the array 76. Each member such as 77, 78, and 79 of the array 76 is a root page-node of a graph of page-nodes. A page-node corresponding to each page on the Web-site (at the desired level of description) is made a member of the array 76. In this manner, all pages contained in a Web-site may have their clickstream data accessed by selecting the appropriate array element corresponding to the selected page. The root page-nodes of the data structure are connected to all forward- and reverse-adjacent page-nodes through the use of pointers. For example, root page-node 71 is forward-adjacent to page-node 74 and reverse-adjacent to page-node 72. This is illustrated by arcs representing pointers 73 and 75 pointing from the base page-node 71 to page-nodes 72 and 74 respectively. Directed arc 73 is stored in the forward pointer storage location of data structure 71, while directed arc 75 is stored in the reverse pointer storage location of data structure 71.

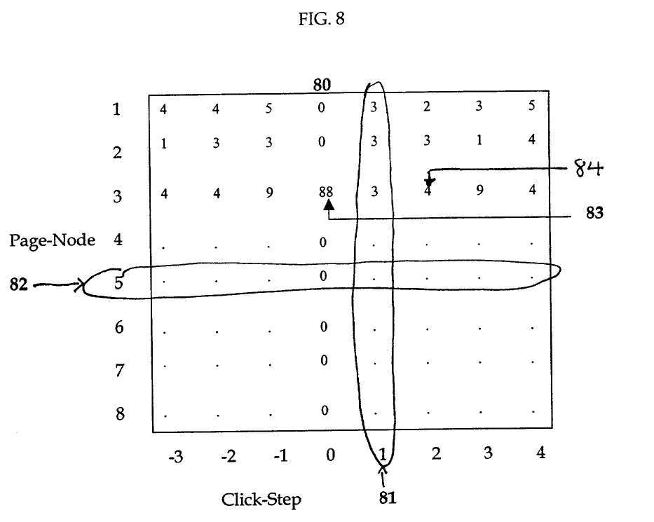

FIG. 8 shows a matrix data structure (COLAP-matrix) 80 used to record the number of transitions from a particular page (focal-node) to other pages. This data structure is an alternative embodiment to the previously described COLAP-graph structure capable of storing the number of traversals passing through each page at various click-steps. A unique matrix may then represent each page in the Web-site. The matrix 80 has vertical columns and horizontal rows. The vertical columns, such as 81, refer to click-steps while the horizontal rows, such as 82, represent pages. The entries of the matrix denote how many times the page corresponding to the horizontal row was accessed a number of click-steps denoted by the vertical column from the focal-node. For instance the “438 corresponding to entry 84 signifies that page “3” was accessed by four sessions two click-steps after the focal-node was accessed. Entry 83 of the matrix is the only member of column 0 to contain a non-zero entry because, by definition, all accesses to the page that is the focal-node must pass through the focal-node at click-step zero. Otherwise, there would be more than one page that would be portrayed as the focal-node. Therefore, only the focal node may possess a non-zero entry in the column corresponding to click-step 0. Such a matrix representation may be constructed from clickstreams for each possible focal-node or for the clickstreams transitioning through a set of focal-nodes. For example, a matrix may be constructed to represent all clickstreams transitioning through four specific pages in a specified order at specified click-steps. These four specific pages however need not be contiguous within the clickstream data.

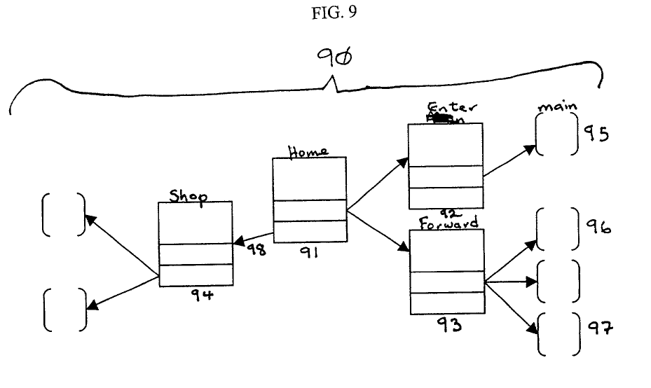

FIG. 9 shows an exemplary model of an alternative embodiment of the hybrid structure of the COLAP-matrices and COLAP-graph used to record the number of transitions from a particular page to other pages. The hybrid COLAP-graph as shown contains two levels of the COLAP-graph data structure 90. The COLAP-graph data structure is centered on the “home” page-node 91. The illustration that the “home” page-node then connects to the “main” page-node 92 and the “forward” page-node 93 demonstrates that the corresponding pages have been accessed one click-step after the “home” page was accessed. The “home” page-node also is connected to the “shop” page-node 94, but its orientation demonstrates that the “shop” page was accessed one click-step before the “home” page. The orientation of the “shop” page-node is demonstrated by viewing directed arc 98 between data structures 91 and 94. Directed arc 98 emanates from the reverse-template portion of data structure 91 and is directed to data structure 94. In this example, the “home” page-node 91, is the first level (root page-node) in the COLAP-graph 90. Page-nodes 95-97, represented as matrices, are the second level of the COLAP-graph 90. These matrices may then be used to terminate the COLAP-graphs, as shown in FIG. 9. For instance in FIG. 9, matrix 95 is the matrix of click steps, centered with page-node “main”, that go through pages “enter” at click-step-1, “home” at click step-2, and “shop” at click-step-3.

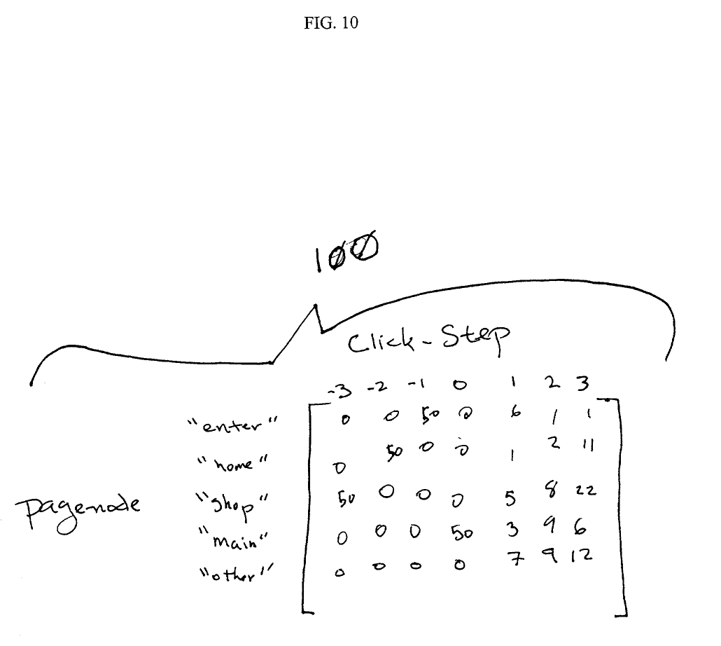

Matrix 100 of FIG. 10 is a detailed version of exemplary matrix 95 of FIG. 9 and contains non-zero entries in click-step columns-1, -2, and -3 in the rows corresponding to the pages “enter”, “home”, and “shop” respectively. The described hybrid COLAP-graph, and associated representation may be implemented with any number of levels of the COLAP-graph data structures such that the COLAP-graph structure is terminated by COLAP-matrices. This embodiment may provide the advantage of a diminished memory requirement to store the COLAP data several click-steps away from the root page-node than for a complete COLAP-graph. Further, it allows for an early termination of the amount of data stored within any hybrid COLAP-graph to a determinable, finite number of click-steps. Determined termination of the COLAP-graph is achieved by using the COLAP-matrices to prevent further growth of the COLAP-graph.

The hybrid COLAP-graph is merely a COLAP-graph terminated by COLAP-matrices. This difference allows the hybrid COLAP-graph to generally possess a smaller number of levels than a corresponding COLAP-graph. The COLAP-matrices then hold the information regarding the levels of the COLAP-graph truncated in the hybrid-COLAP graph in an array format.

It will be noted by those of skill in the art that these alternative methods of storing transaction or clickstream data have the further advantage of aggregation of the transaction or clickstream data. Raw transaction or clickstream data requires storage space on the order of the number of separate transactions stored in the data set. However, the various methods of creating data structures to represent transaction or clickstream data may require less storage space than saving a corresponding list of transaction or clickstream data. The amount of storage space required as a result of these database constructions may depend on the number of distinct transaction types, the total number of data attributes, and the total number of steps in the time horizon.

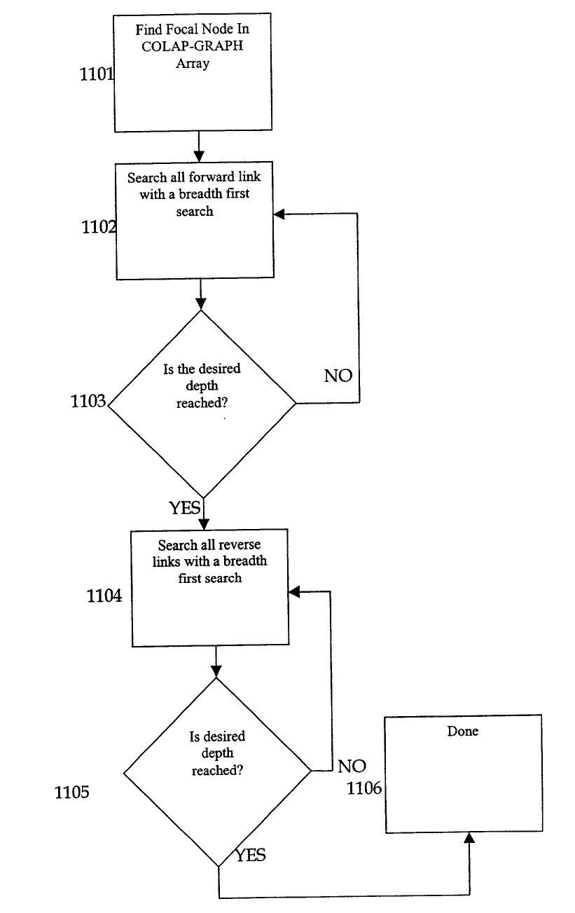

FIG. 11 shows a flow diagram of the present invention searching and processing an array of root nodes to obtain the desired data from a COLAP-graph array. The COLAP-graph array is searched 1101 for the array element corresponding to the focal node. Then, all forward and reverse paths of the COLAP-graph corresponding to the focal node are searched 1102-1105 until the requested depth of the search is reached. The search determines all of the page-nodes that are within a given number of forward or reverse click-steps from the focal-node. This search is performed for transitions occurring before and after the transition to the focal node.

The preferred embodiment is for the present invention to be executed by a computer as software stored in a storage medium. The present invention may be executed as an application resident on the hard-disk of a PC computer with an Intel Pentium microprocessor and displayed with a monitor. The computer may be connected to a mouse or any other equivalent manipulation device.

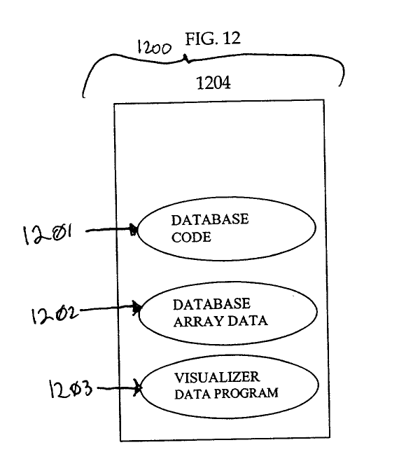

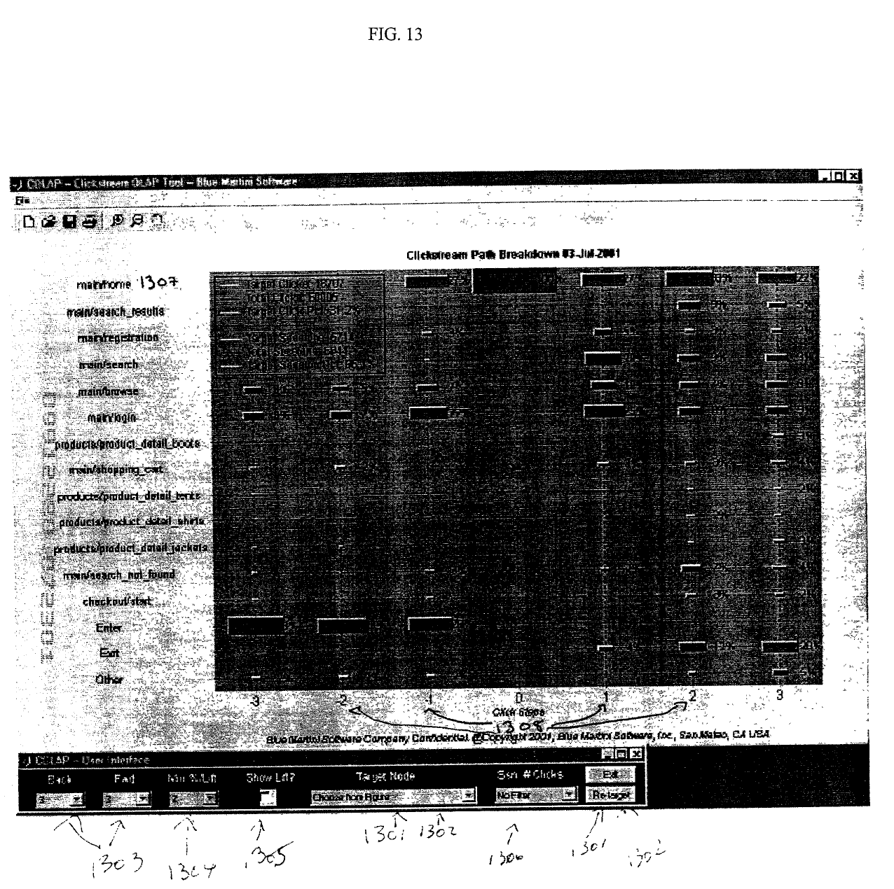

Referring to FIG. 12, part of the process of searching, processing, and visualizing the transaction or clickstream data may be executing the data storage code (software) 1201 stored on the program storage device 1204. This code may access the array data 1202 and visualizer data program 1203 to create a GUI 1300 for interaction with a user, as shown in FIG. 13.

FIG. 12 shows a program storage device 1204 having storage areas 1201-1203. Information is stored in the storage area in a well-known manner that is readable by a machine, and that tangibly embodies a program of instructions executable by the machine for performing the method of the present invention described herein for storing and interactively viewing clickstream data. Program storage device 1204 could be volatile memory, such as dynamic random access memory or non-volatile memory, such as a magnetically recordable medium device, such as a hard drive or magnetic diskette, or an optically recordable medium device, such as an optical disk. Alternately, other types of storage devices could be used.

In the current embodiment, a user may execute a plurality of functions, some of which are shown in FIG. 13, to visualize clickstream data. The functions allow the user to focus on the clickstream data most important to the user's current needs. These functions and their parameters include:

RETARGET 1301—Centers the visualization tool on a selected page 1307. In this example, the selected page is “main/home”. The selected page (focal-node) is centered at click-step 0 and its COLAP box-plot box size will be 100%. The other pages displayed by the visualization tool are those with pages that are within a user-specified number of forward or backward transitions from the focal node. The size of the rectangle representing a page on a screen relative to the size of the rectangle representing another page on the screen represents the percentage of time before or after the focal-node they are accessed. The box-plot boxes, each representing a page, are then drawn on a vertical column. The vertical columns 1308 represent the number of forward click-steps or reverse click-steps between the given page and the targeted focal-node.

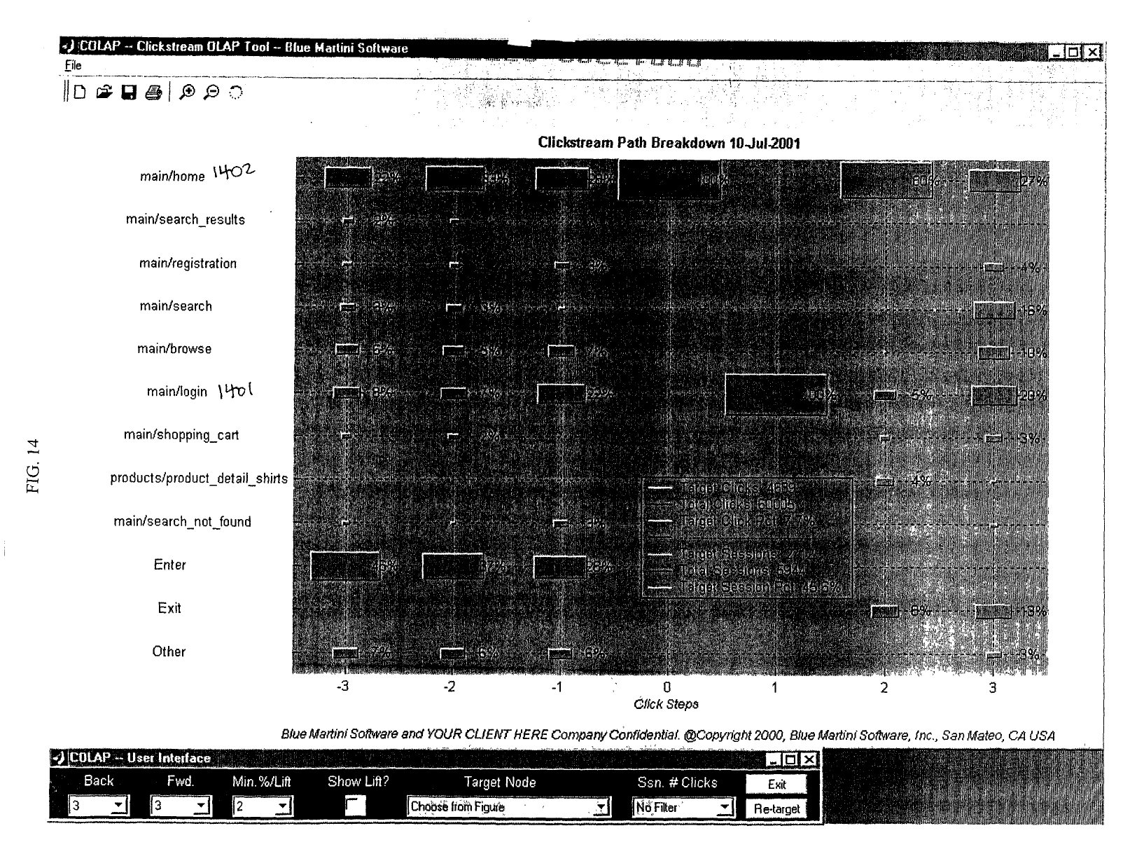

RETARGET-on-TARGET 1302—The function employs the targeting information currently being used be the COLAP visualizer. The visualizer then adds one or more constraint(s) to the data being presented to the user and creates a new visualization taking into account the additional constraint(s). The function may be applied repeatedly to focus on, for example, all clickstreams transitioning through four specific pages in a specified order. However, these pages do not need to be contiguous in the clickstream data. Each time the function is applied, it acts as an “AND” filter on the displayed data. FIG. 14 demonstrates a visualization of the present invention after the RETARGET-on-TARGET feature has been used. In this particular instance, “main/login” 1401 is targeted after “main/home” 1402 was targeted, as indicated by the box at click-step zero corresponding to “main/home” 1403 and the box at click-step one corresponding to “main/login” 1404 both being 100% size. The 100% size demonstrates that all page-requests relevant to the current display went through box 1403 at click-step zero and box 1404 at click-step one.

Time Horizon Selection 1303—The parameter allows the user to select the number of transitions before and after the focal-node that the visualizer will display.

Min Box Size 1304—The parameter defines the smallest individual page size (as a percentage of all page total viewings at any click step) that will be displayed by the visualizer. All pages below this threshold will be consolidated into an “other” box.

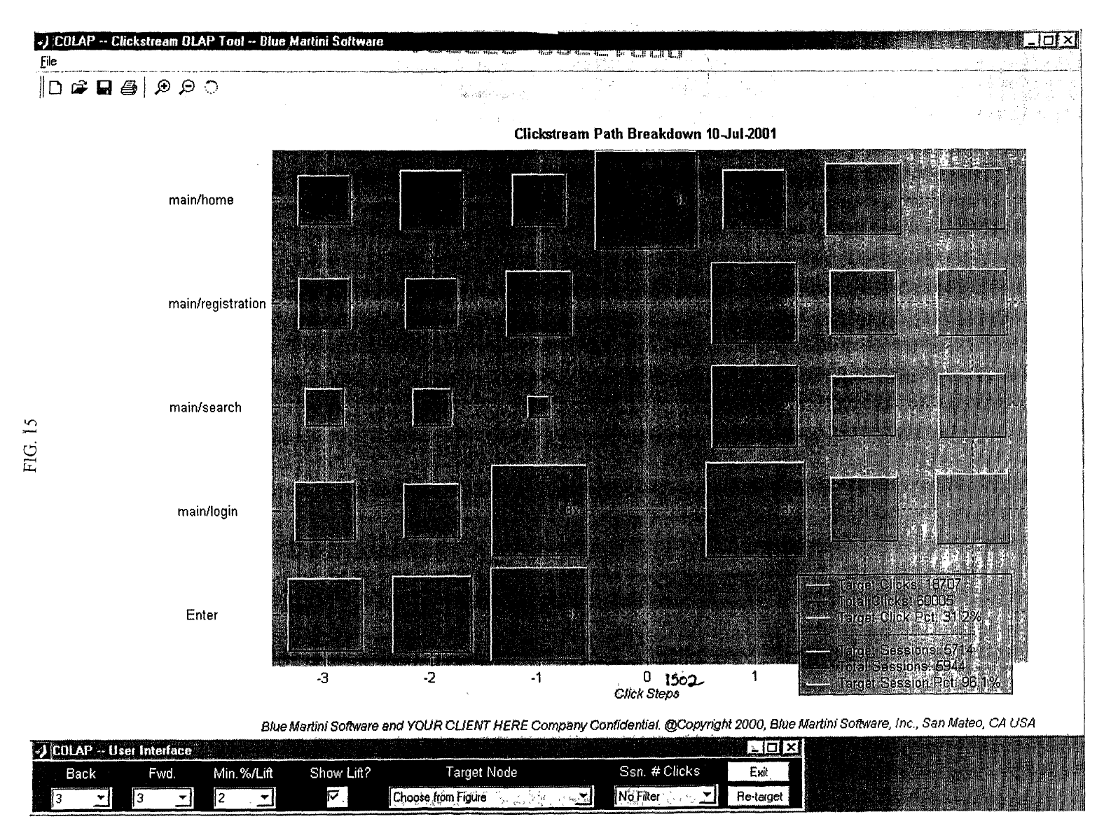

Show Lift 1305—The click box enables the visualizer to display the “lift” associated with each page. “Lift” is defined as the probability the page-node is accessed at that particular click-step in sessions consistent with the current targeting parameters, divided by the probability the page-node is accessed at that particular click-step over all included sessions. FIG. 15 demonstrates a visualization of the present invention after the “show lift” feature is selected. This particular graphic is centered at the “main/home” page since its corresponding box 1501 is centered at click-step zero 1502. The boxes on the page correspond to the lift of each page at the corresponding click-step.

Session number of clicks 1306—Allows the user to filter and display only a chosen set of sessions within the clickstream data. In particular, these parameters allow those sessions with certain numbers of clicks to be displayed. If the clickstream falls within the parameters set by the menu, the data is displayed. Otherwise, the clickstream data is omitted from the visualized output. Other embodiments could include other parameters on which clickstream data requests are focused. These parameters could include, but would not be limited to: buyer, browser, sex, income, age, college education, or other clickstream parameters, including but not limited to Last Page, Referring Page, Referring Query, Request Date, Request Time, Session Number, or Template Number.

The embodiments described herein are merely illustrative of the principles of this invention. Other arrangements and advantages may be devised by one skilled in the art without departing from the spirit or scope of the invention. Accordingly, the invention should be deemed not to be limited to the above detailed description. Various other embodiments and modifications to the embodiments disclosed herein may be made by those skilled in the art without departing from the scope of the following claims.

What is claimed is:

1. A method of analyzing transaction data representing a plurality of transactions, comprising;
(a) selecting data representing a first label from said transaction data;
(b) identifying a first set of transaction data, said first set of transaction data representing:
said first label and said first label's associated data attributes; one or more labels and their associated data attributes performed before said first label;
and one or more labels and their associated data attributes performed after said first transaction; and
(c) presenting said first set of transaction data based upon said data representing said first label.

2. The method of claim 1, wherein:
said labels comprise pages; and
said transaction data comprises clickstream data.

3. The method of claim 1, wherein:
said step of identifying a first set of transaction data includes analyzing transaction session data.

4. The method of claim 1, wherein:
the step of presenting said transaction data includes displaying a graphical data representation of said first set of transaction data.

5. The method of claim 4, wherein:
the step of presenting said transaction data comprises displaying a graphical data representation of said first set of transaction data on a single screen.

6. The method of claim 1, further comprising the step of:
performing transaction measurement calculations on said transaction data.

7. The method of claim 6, wherein said step of performing said transaction measurement calculations is performed before the step of presenting said first set of transaction data.

8. The method of claim 6, further comprising the step of:
combining said transaction data into a data structure.

9. The method of claim 8, wherein:
said data structure is a COLAP-graph data structure.

10. The method of claim 9, further comprising the step of:
storing said combined transaction data COLAP-graph data structure on a computer-readable medium.

11. The method of claim 8 wherein:
said data structure is a hybrid COLAP-graph data structure.

12. The method of claim 8 wherein:
said data structure is a plurality of multidimensional arrays.

13. The method of claim 1, wherein said group of individual transactions are ordered.

14. The method of claim 13, wherein said order is chronological.

15. A method of analyzing transaction data representing a plurality of transactions comprising;
selecting data representing a subset of said plurality of labels from said transaction data;
for the labels in said subset, identifying a first set of transaction data, said first set of transaction data representing:
said subset of labels and said subset labels' associated data attributes,
one or more labels and their associated data attributes performed before any of said subset of labels, and
one or more labels and their associated data attributes performed after any of said subset of transactions; and
for each label in said subset, presenting said first set of transaction data.

16. A computer-readable medium having stored thereon a data structure representing transaction data comprising:
a first field containing data representing a number occurrences of a label; and
a second field containing data representing transitions between said first label and the same or another label.

17. The computer-readable medium and data structure of claim 16, wherein:
said first field contains data attributes of transaction data passing through said first label.

18. The computer-readable medium and data structure of claim 16, further comprising:
a third field containing data representing an identification of said first label.

19. The computer-readable medium and data structure of claim 17, wherein:
said third field contains the name of said first label.

20. The computer-readable medium and data structure of claim 17, further comprising:
a graph of said data structures.

21. The computer-readable medium and data structure of claim 17, wherein:
said data representing a number of visits to a first label are stored in an OLAP cube.

22. The computer-readable medium and data structure of claim 20, wherein:
said OLAP cube further stores data attributes of transaction data passing through said first label.

23. The computer-readable medium and data structure of claim 22, further comprising:
a graph of said data structures.

24. The computer-readable medium and data structure of claim 16, wherein:
said data representing a number of visits to a label are stored in a plurality of multidimensional arrays.

25. The computer-readable medium and data structure of claim 24, wherein:
said plurality of multidimensional arrays stores transaction attribute data in addition to said data representing a number of visits to a label.

26. The computer-readable medium and data structure of claim 25, further comprising:
a graph of said data structures.

27. The computer-readable medium and data structure of claim 16 wherein:
said representations of transitions between individual labels are pointers.

28. An apparatus for analyzing transaction data comprising a group of transactions comprising:
means for selecting a label of interest from a said transaction data;
means for identifying one or more adjacent labels performed before or after said label of interest, said transaction data comprising an identification of said one or more adjacent labels; and
presenting said transaction data based on said label of interest.

29. The apparatus of claim 28, wherein:
said labels comprise pages; and
said transaction data is clickstream data.

30. The apparatus of claim 29, wherein:
means for selecting an individual label from a group of individual labels comprises means for selecting a plurality of individual labels within a set of transaction data.

31. In a computer system having a graphical interface including a display device and a selection device, a method of displaying information on the display device in a menu form and accepting menu selection input from a user, the method comprising:
retrieving a set of menu entries for the menu, each of the menu entries representing an action to perform upon transaction data;
displaying the set of menu entries on the display device;
displaying a set of parameters on the display device;
providing the user an opportunity to modify said set of parameters;
receiving an indication of a menu entry selection from the user via the selection device; and
in response to said indication of a menu entry selection, performing a search of a database for transaction data that meet criteria established by said menu entry selection and by said set of parameters.

32. A set of application program interfaces embodied on a computer-readable medium for execution on a computer in conjunction with an application program that presents transaction data of interest to a user, comprising:
a first interface that receives parameters for a set of transaction data attributes;
a second interface that receives an individual label identifier;
a third interface that receives transaction data; and
a fourth interface that receives parameters for a first group of transaction data and said individual label identifier and returns a second group of transaction data, wherein said second group of transaction data matches said individual transaction's identifier and said first group of transaction data attributes.

33. A method of aggregating data, comprising:
creating a COLAP-graph representation of said data.

34. The method of claim 33, wherein said data is transaction data.

35. The method of claim 34, further comprising:
storing said COLAP-graph on a computer readable medium.

36. The method of claim 33, wherein:
said COLAP-graph is a hybrid COLAP graph.

37. A method of analyzing clickstream data comprising:
(a) gathering clickstream data from a Web-site;
(b) creating a COLAP-graph representation of said clickstream data, said COLAP-graph containing a separate data structure for each page in said clickstream data;
(c) visualizing said clickstream data on a display device;
(d) selecting data representing a subset of said plurality of pages from said clickstream data;
(e) for each page in said subset, identifying a first set of transaction data, said first set of transaction data representing said subset of pages and said subset pages' associated data attributes, one or more pages and their associated data attributes performed before any of said subset of pages, and one or more pages and their associated data attributes performed after any of said subset of transactions; and
(f) presenting said first set of transaction data for each page in said subset.
